(19) United States
(12) Patent Application Publication
(10) Pub. No.: US 2014/0318337 A1
(43) Pub. Date: Oct. 30, 2014

(54) LENS CUTTING DEVICE

(71) Applicant: HON HAI PRECISION INDUSTRY CO., LTD., New Taipei (TW)

(72) Inventor: CHIH-HAO CHU, New Taipei (TW)

(73) Assignee: HON HAI PRECISION INDUSTRY CO., LTD., New Taipei (TW)

(21) Appl. No.: 14/256,084

(22) Filed: Apr. 18, 2014

(30) Foreign Application Priority Data
Apr. 25, 2013 (TW) 102114754

(51) Int. Cl. B26D 7/32; B26D 1/01

(52) U.S. Cl. CPC B26D 7/32; B26D 1/01
USPC 83/102

(57) ABSTRACT

A lens cutting device for cutting lenses of a molded lens member from supporting scraps includes a supporting portion, a sliding portion slidably connected to the supporting portion, a separating portion positioned on the sliding portion for keeping the molded lens member thereon, and a cutting portion positioned above the separating portion for cutting the lenses from the scrap. The supporting portion includes a bottom plate defining a first opening and a second opening arranged along a first linear direction. The sliding portion drives the separating portion to move along the first linear direction to selectively align the separating portion with the first opening or with the second opening.

### FIELD

The present disclosure relates to cutting devices, and particularly to a lens cutting device for cutting lenses manufacturing by an injection molding process.

### BACKGROUND

Lenses may be manufactured by an injection molding process. To increase a lens manufacturing efficiency, a multi-cavity injection mold is employed to manufacture a number of lenses in an injection molding process. The lenses should be separated from each other by a cutting process.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is an isometric view of a lens cutting device, according to an exemplary embodiment of the present disclosure.

FIG. 2 is an exploded view of the lens cutting device of FIG. 1.

FIGS. 3-9 are schematic views showing a lens cutting process using the lens cutting device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

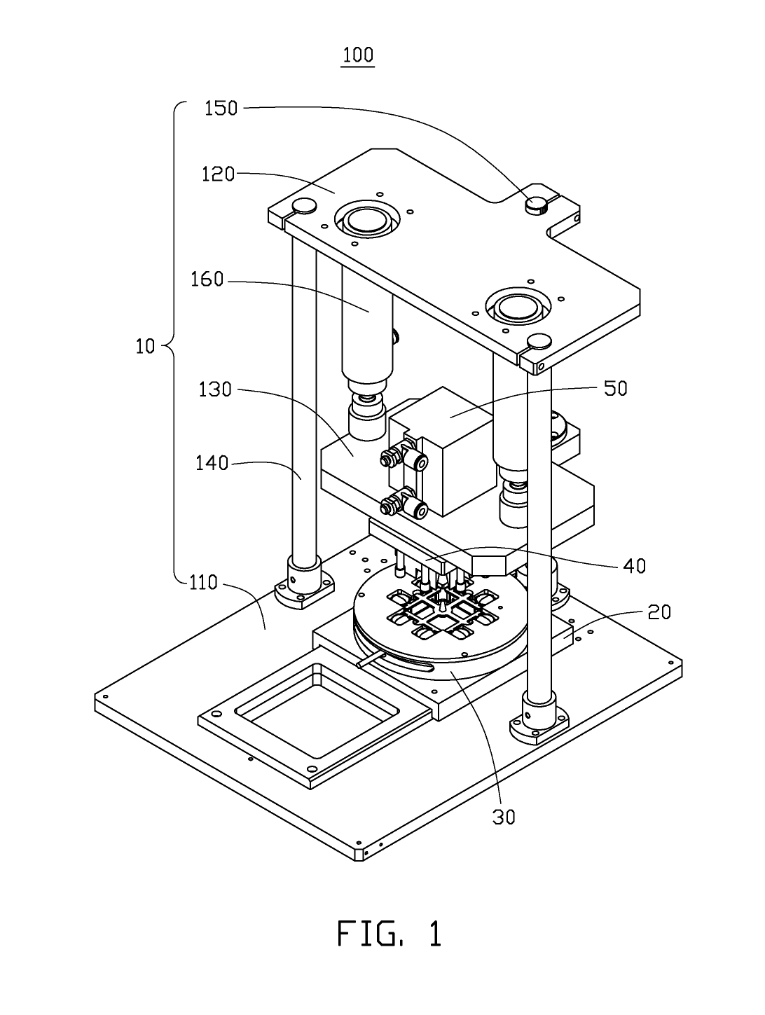

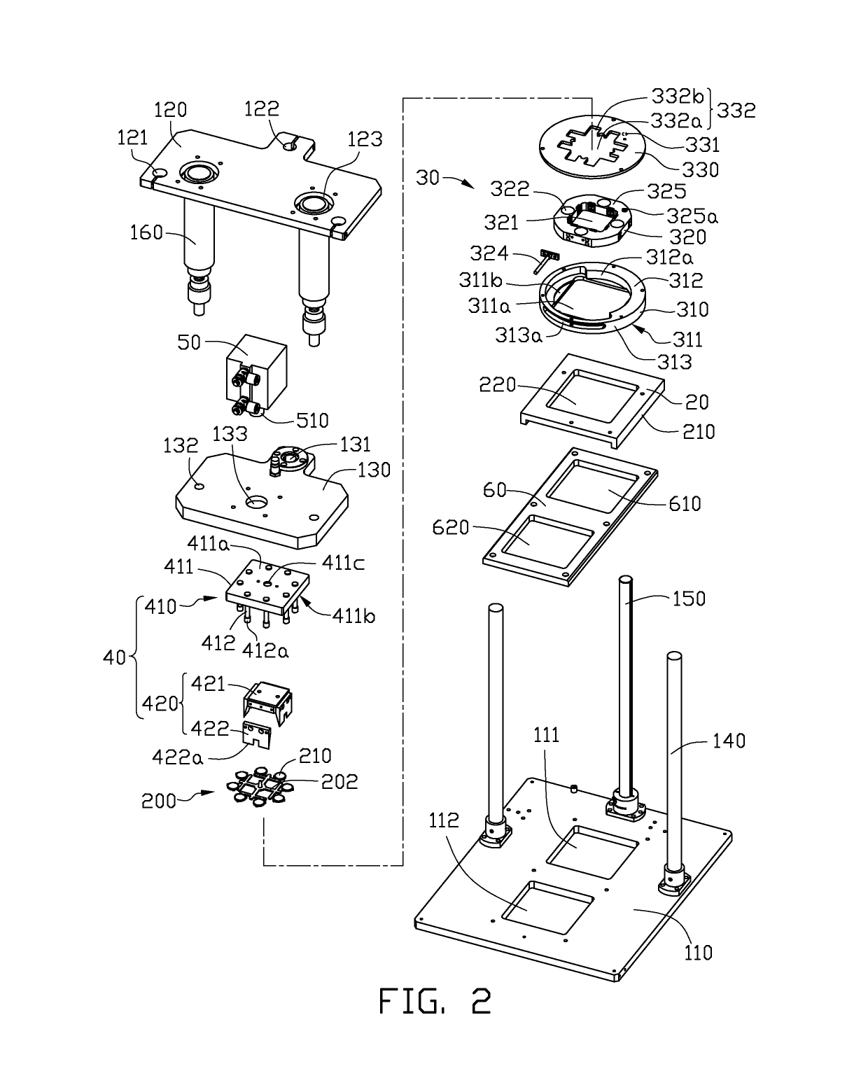

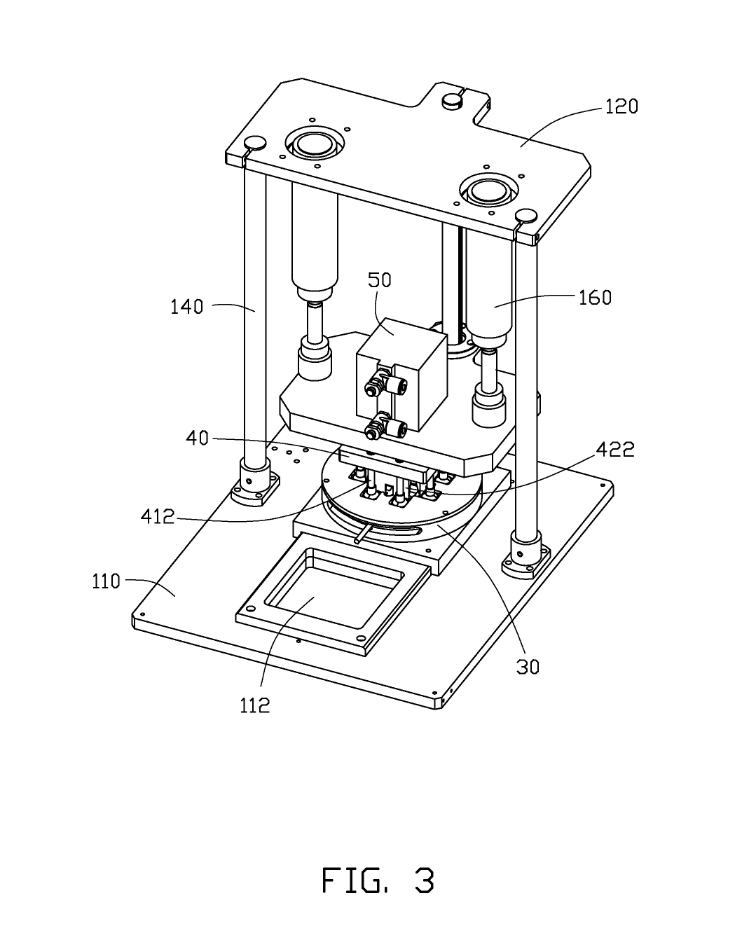

FIGS. 1-2 show one embodiment of a lens cutting device 100 for cutting a molded lens member 200. The molded lens member 200 includes a number of lenses 201 connected to a scrap 202. The lens cutting device 100 includes a supporting portion 10, a sliding portion 20, separating portion 30, a cutting portion 40, and a driving portion 50.

The supporting portion 10 includes a bottom plate 110, a top plate 120, a movable plate 130, two first supporting posts 140, a second supporting post 150, and two retractable bars 160.

The bottom plate 110 defines a first opening 111 and a second opening 112. The first opening 111 allows the scrap 202 separated from the lenses 201 to pass therethrough, and the second opening 112 allows the lenses to pass therethrough.

The top plate 120 defines a first fixing hole 121, a second fixing hole 122, and two third fixing holes 123.

The movable plate 130 defines a pivot hole 131 corresponding to the second fixing hole 122, two fourth holes 132 corresponding to the third holes 123, and a through hole 133 in a center thereof.

The first supporting posts 140 are positioned at opposite sides of the first opening 111. An end of each first supporting post 140 is fixed on the bottom plate 110, and the other end of the first supporting post 140 is fixedly inserted into a corresponding first fixing hole 121.

The second supporting post 150 is positioned at a side of the first opening 111 away from the second opening 112. An end of the second supporting post 150 is fixed on the bottom plate 110, and the other end of the second supporting post 150 passes through the pivot hole 131 and is fixedly inserted into the second fixing hole 122.

An end of each retractable bar 160 is fixedly inserted into a corresponding third fixing hole 123, and the other of the retractable bar is fixedly inserted into a corresponding fourth fixing hole 132. In this embodiment, the retractable bars 160 are cylinders.

The sliding portion 20 is slidably connected to the bottom plate 110 and slides between the first opening 111 and the second opening 112, in other words, the sliding portion 20 can slide from a position upon the first opening 111 to a position upon the second opening 112. In detail, the sliding portion 20 is guided by a guiding plate 60 positioned on the bottom plate 10. The guiding guide plate 60 defines a third opening 610 corresponding to the first opening 111 and a fourth opening 620 corresponding to the second opening 112. The sliding portion 20 includes two rims 210 formed on opposite sides of the sliding portion 20, the rims 210 sandwich the guiding plate 60 therebetween. The sliding portion 20 defines a fifth opening 220 in a central portion, in a movement of the sliding portion 20, the fifth opening 220 can be selectively aligned with the first opening 111 or with the second opening 112. In another embodiment, the sliding portion 20 can be guided by rails, or by guiding grooves, or the like.

The separating portion 30 is positioned on the sliding portion 20. The separating portion 30 includes a loading member 310 fixed on the sliding portion 20, a rotatable member 320, and a restricting member 330. The loading member 310 is substantial circular. The loading member 310 includes a first surface 311 facing toward the sliding portion 20, a second surface 312 opposite to the first surface 311, and a peripheral surface 313 connected to the first surface 311 and the second surface 312. The separating portion 30 defines a rectangular hole 311a in the first surface 311 and a receiving hole 312a in the second surface 312. The rectangular hole 311a and the receiving hole 312a communicate with each other. In this embodiment, the receiving hole 312a has two semi-circular portions having different diameters. The separating portion 30 includes a step surface 311b formed between the rectangular hole 311a and the receiving hole 312a. The separating portion 30 defines a slot 313a in the peripheral surface 313. The slot 313a communicates with the receiving hole 312a.

The rotatable member 320 is substantially ring-shaped. The rotatable member 320 is received in the receiving hole 312a and abuts the step surface 311b. The rotatable member 320 defines a central hole 321 and a number of peripheral holes 322 around the central hole 321. In one embodiment, the number of the peripheral holes 322 is four, and the peripheral holes 322 are uniformly distributed around the central hole 321. The rotatable member 320 includes a handle 324 on a peripheral surface of the rotatable member 320. The handle 324 passes through the slot 313a. The handle 324 is slidable along the slot 313a. A shape and size of the central hole 321 is determined according to a shape and size of the scrap 202, in other words, the shape and size of the central hole 321 must be such as to ensure the passage of the scrap 202 through the central hole 321. A shape and size of each peripheral hole 322 is determined according to a shape and size of the lenses 201, in other words, the shape and size of the peripheral hole 322 is such as to ensure that the lenses 201 pass through the peripheral hole 322. The rotatable member 320 includes a positioning ball 325a positioned in a top surface 325 of the rotatable member 320. A portion of the positioning ball 325a protrudes from the top surface 325 for a predetermined distance. The positioning ball 325a is elastically received in the top surface 325, thus the positioning ball 325a can be pressed flush into top surface 325.

The restricting member 330 is fixedly connected to the second surface 312 of the loading member 312. A shape and size of the restricting member 330 correspond to those of the loading member 310. The restricting member 330 defines a restricting hole 332 for restraining the molded lens member 200 in a cutting process. In detail, the restricting hole 332 includes a central portion 332a and a number of peripheral portions 332b around the central portion 332 and communicating with the central portion 332a. The central portion 332a is configured for receiving the scrap 202, and the peripheral portions 332b are configured for receiving the lenses 201. The restricting member 330 defines a positioning recess 331 corresponding to the positioning ball 325a. The positioning ball 325a is engaged into the positioning recess 331 to keep the rotatable member 320 at an original position. When the rotatable member 320 is at the original position, the peripheral portions 332b are staggered from the peripheral hole 322 along a direction substantially parallel to a rotating axis of the rotatable member 320.

The cutting portion 40 is positioned above the first opening 111. The cutting portion 40 includes a keeping member 410 and a cutting member 420. The keeping member 410 includes a fixing board 411 and a number of contacting posts 412 corresponding to the peripheral portions 332b. The fixing board 411 includes a third surface 411a and a fourth surface 411b opposite to the third surface 411a. The fixing board 411 defines a connecting hole 411c passing through the third surface 411a and the fourth surface 411b. The contacting posts 412 are formed on the fourth surface 411b. Each contacting post 412 includes an elastic contacting head 412a formed on a distal end of the contacting post 412. The cutting member 420 includes a connecting board 421 and a number of cutting tools 422 fixed on peripheral sides of the connecting board 421. In this embodiment, the connecting board 421 is substantially rectangular. Each cutting tool 422 includes two blades 422a. The connecting board 421 is fixed on the fourth surface 411b, and each blade 422a is adjacent to a corresponding contacting post 412.

The driving portion 50 is fixed on the movable plate 130 and connecting with the cutting portion 40. The driving portion 50 drives the cutting member to move along a cutting direction. The driving portion 50 includes a driving shaft 510. The driving shaft 510 passes through the through hole 133 and fixedly inserts into the connecting hole 411c. In this embodiment, the driving portion 50 is a cylinder which drives the driving shaft 510 to move along the cutting direction.

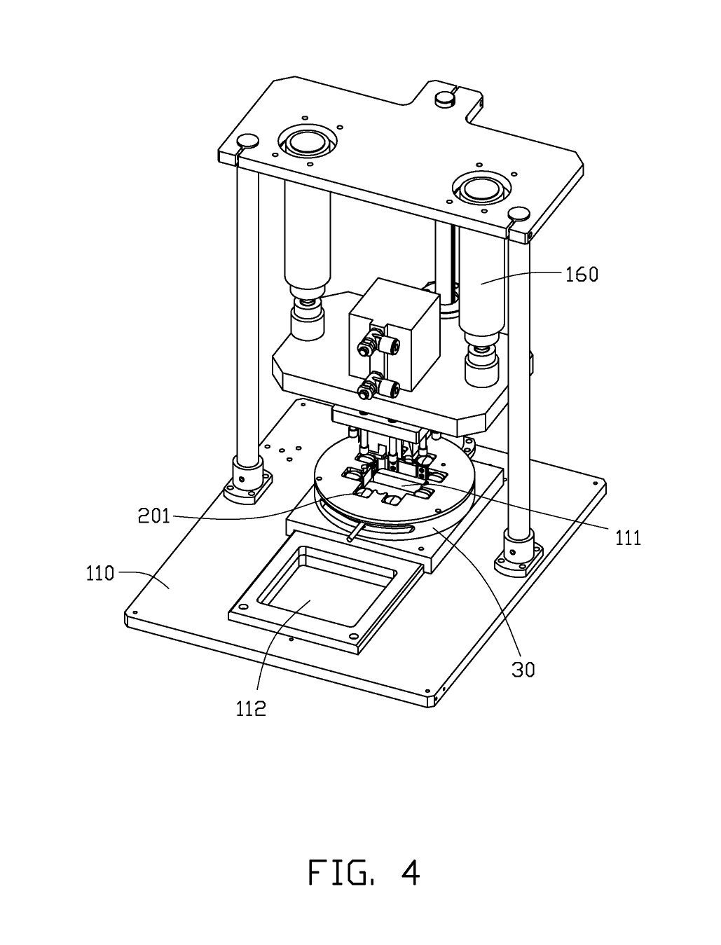

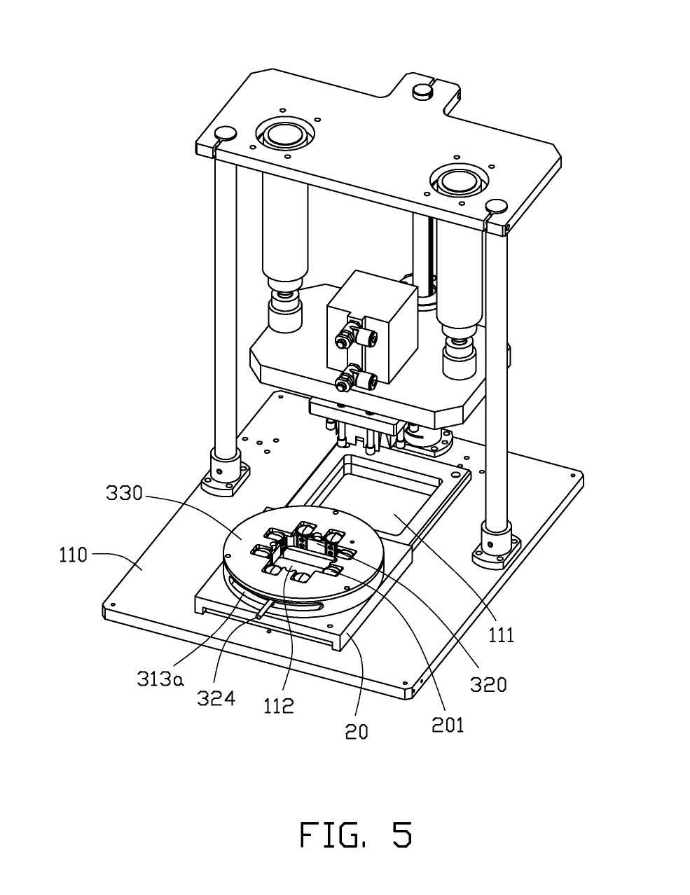

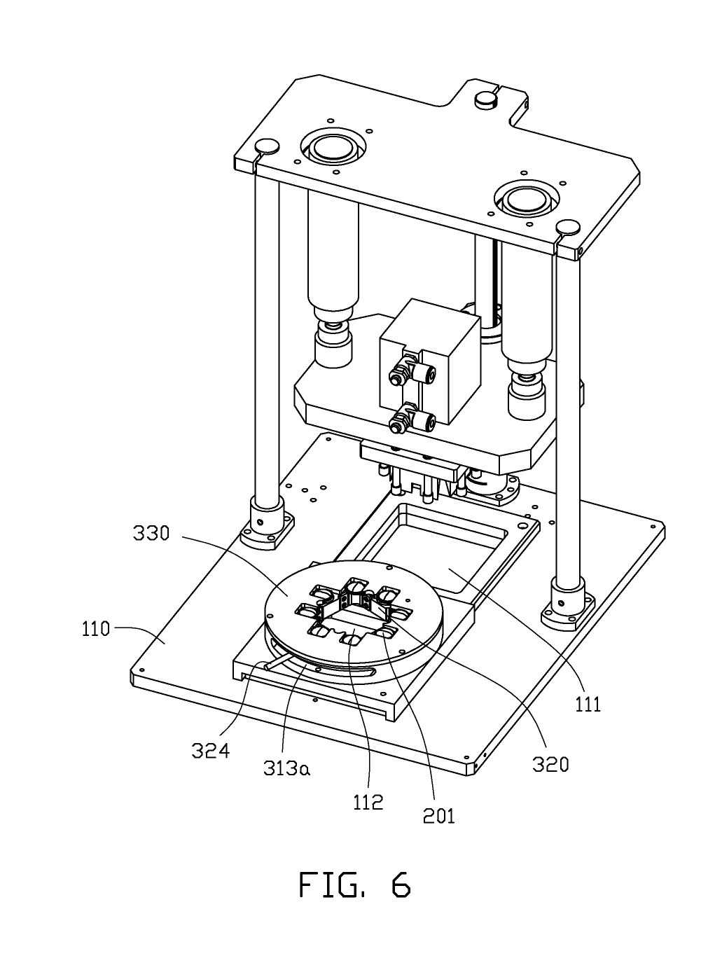

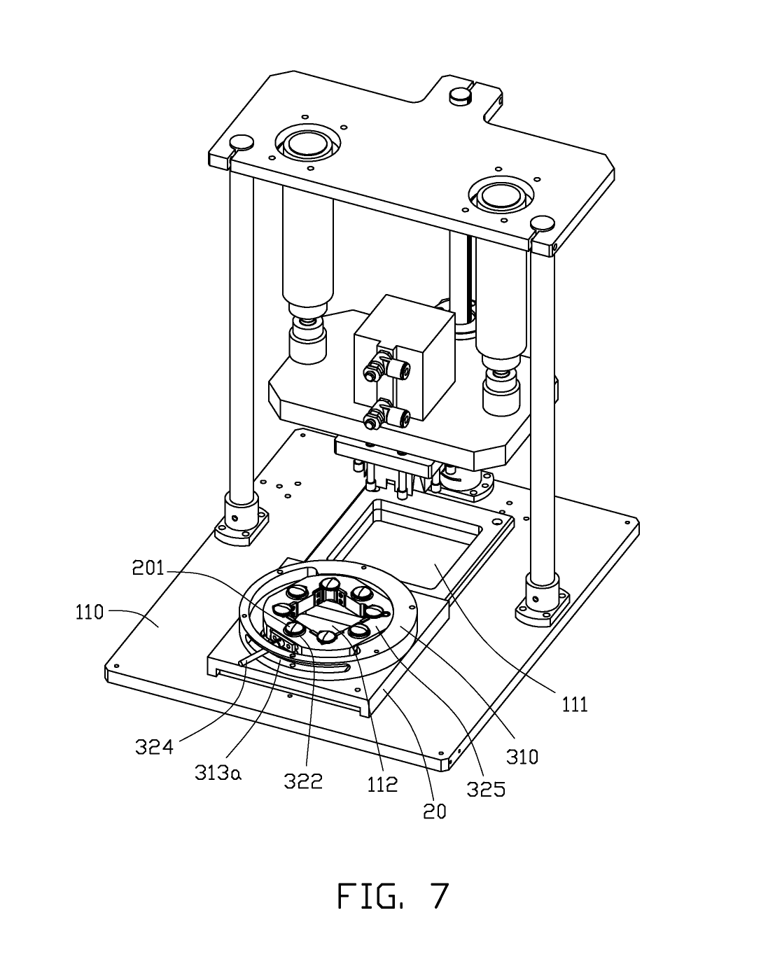

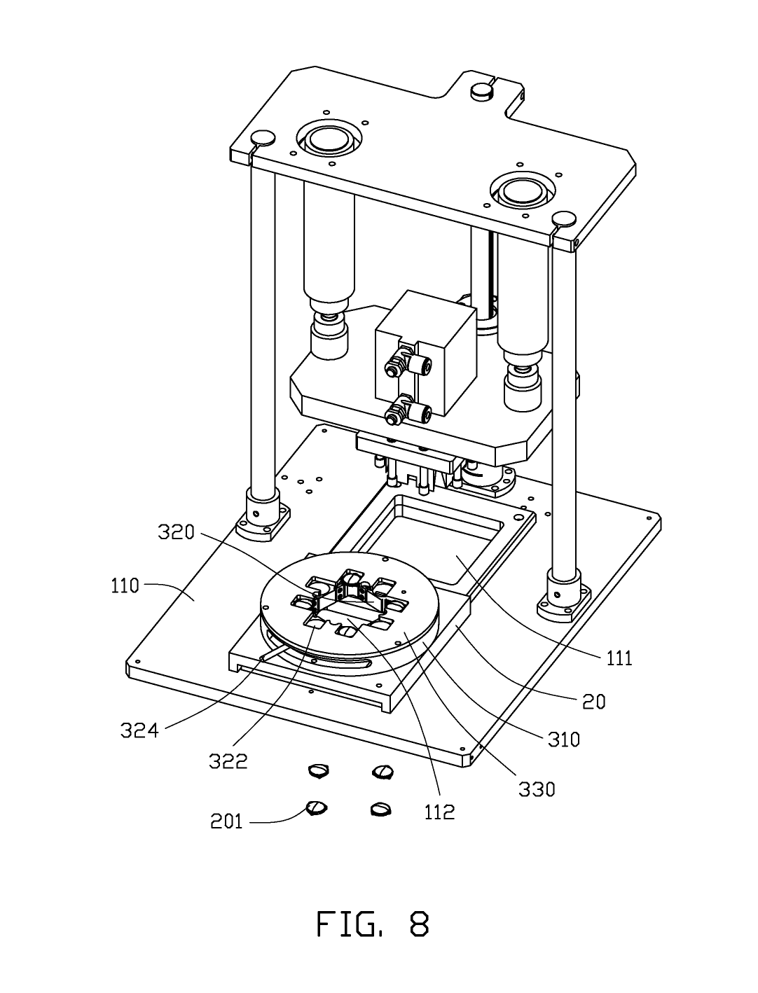

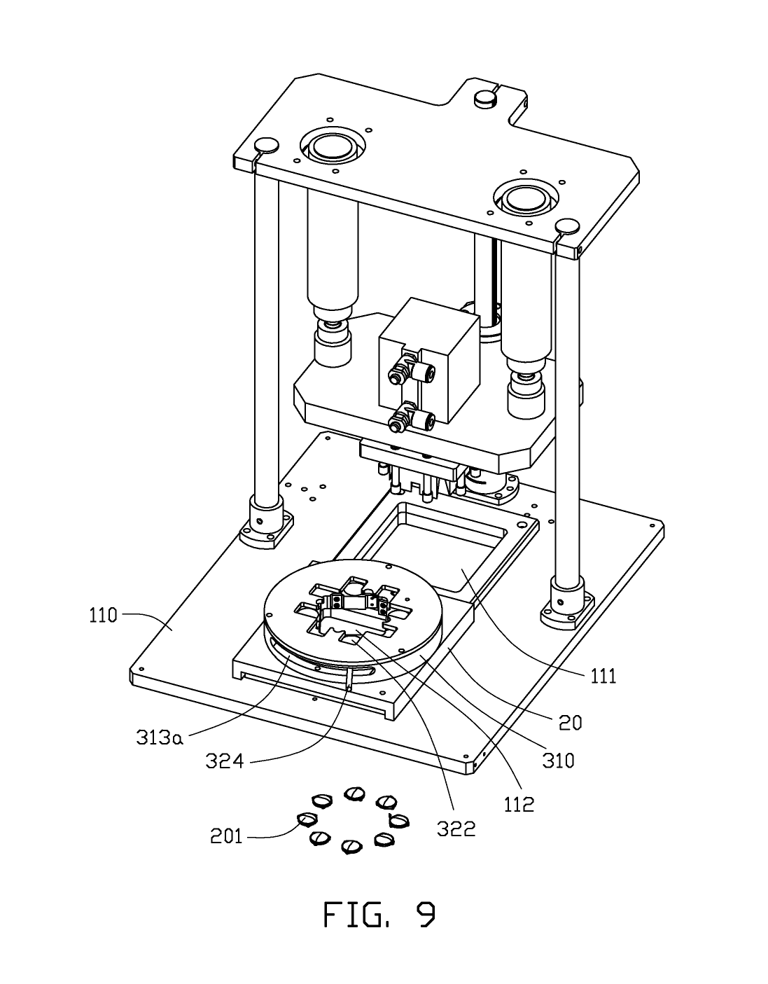

FIGS. 4-9 show a cutting process using the lens cutting device 100 to cut the molded lens member 200. In the cutting process, the sliding portion 20 is slid above the first opening 111, the molded lens member 200 is received into the restricting hole 332, the scrap 202 is restricted in the central portion 332a, and the lenses 201 are respectively restrained in the peripheral portions 332b. The retractable bars 160 drive the movable plate 130 to move toward the bottom plate 110 for a predetermined distance, the driving portion 50 drives the cutting portion 40 to move toward the molded lens member 200, the contacting posts 412 make contact with lenses 201, and the cutting tools 422 cut the lenses 201 from the scrap 202. The cut scrap 202 falls from the lenses 201, passing through the central portion 332a of the restricting hole 332, the central hole 321 of the rotatable member 320, the fifth opening 220 of the sliding portion 20, the third opening 610 of the guiding plate 60, and the first opening 111 of the bottom plate 110. A collecting tray (not shown) is positioned below the first opening to collect the cut scraps 202.

The sliding portion 20 is slid above the second opening 112. The rotatable member 320 is rotated for a predetermined first angle to align the peripheral holes 322 with one half of the peripheral portions 332b of the restricting member 330, the lenses 201 in the aligned half of the peripheral portions 332b fall down, passing through the peripheral portions 332b of the restricting hole 332, the peripheral holes 322 of the rotatable member 320, the fifth opening 220 of the sliding portion 20, the fourth opening 620 of the guiding plate 60, and the second opening 112 of the bottom plate 110. A collecting tray (not shown) is positioned below the first opening to collect the cut lenses 201. The rotatable member 320 is rotated for a predetermined second angle to align the peripheral holes 322 to the remaining half of the peripheral portions 332b of the restricting member 330.

In this embodiment, the first angle is twice the magnitude of the second angle, in detail, the first angle is about 23 degrees, and the second angle is about 46 degrees.

The lens cutting devices 100 can cut a number of lenses in one operation, to increase cutting efficiency. Furthermore, the lens cutting device 100 makes cut lenses and scraps fall through different openings, therefore the cut lenses and the scraps are separated, keeping the lenses and the scrap from mixing with each other.

The present embodiments and their advantages are apparent from the foregoing description, and various changes may be made thereto without departing from the spirit and scope of the disclosure or sacrificing all of its material advantages, the examples hereinbefore described merely being exemplary embodiments of the disclosure.

What is claimed is:

1. A lens cutting device for cutting a molded lens member, the molded lens member comprising a scrap and a plurality of lenses connected to the scrap, the lens cutting device comprising:
a supporting portion comprising a bottom plate, the bottom plate defining a first opening and a second opening, the first opening and the second opening being arranged along a first linear direction;
a sliding portion slidably connected to the bottom plate;
a separating portion positioned on the sliding portion for keeping the molded lens member thereon; and
a cutting portion positioned above the separating portion for cutting the lenses from the scrap, the sliding portion driving the separating portion to move along the first linear direction to selectively align the separating portion with the first opening or the second opening, when the separating portion being aligned with the first opening, the separating portion releasing the cut scrap to fall through the first opening, and when the separating portion being aligned with the second opening, the separating portion releasing the cut lenses to fall through the second opening.

2. The lens cutting device of claim 1, wherein the supporting portion comprises a top plate, a movable plate, two first supporting posts, a second supporting post, and two retractable bars, an end of each of the first supporting posts and the second supporting post is fixedly connected to the bottom plate, the other end of each of the first supporting posts and the second supporting post is fixedly connected to the top plate, the movable plate is slidably connected to the second supporting post between the bottom plate and the top plate, an end of each of the retractable bars is fixedly connected to the top plate, the other end of each of the retractable bars is connected to the movable plate to drive the movable plate to move along the second supporting bar.

3. The lens cutting device of claim 1, wherein the supporting portion comprises a guiding plate positioned on bottom plate for guiding the sliding portion to slide along the first linear direction, the guiding plate defines a third opening corresponding to the first opening and a fourth corresponding to the second opening.

4. The lens cutting device of claim 3, wherein the sliding portion comprises two rims formed on two opposite sides of the sliding portion, and the rims sandwich the guiding plate therebetween.

5. The lens cutting device of claim 3, wherein the sliding portion defines a fifth opening for allowing the cut scrap and lenses to pass therethrough.

6. The lens cutting device of claim 2, wherein the separating portion comprises a loading member, a rotatable member, and a restricting member, and wherein the loading member is fixed on the sliding portion, the restricting member is fixed on a surface of the loading member away from the sliding portion, and the rotatable member is rotatably sandwiched between the loading member and the restricting member.

7. The lens cutting device of claim 6, wherein the restricting member defines a restricting hole, the restricting hole comprises a central portion and a plurality of peripheral portions around the central portion and communicating with the central portion, the central portion is configured for receiving the scrap, the peripheral portions are configured for receiving the lenses, the rotatable member defines a central hole corresponding to the central portion of the restricting hole and a plurality of peripheral holes around the central hole, and when the rotatable member is at the original position, the peripheral hole are staggered from the peripheral portions along a direction substantially parallel to a rotatable axis of the rotatable member, and when the rotatable member is rotated for a predetermined angle, each peripheral hole is aligned with a peripheral portion along the rotatable axis of the rotatable member.

8. The lens cutting device of claim 7, wherein the loading member defines a rectangular hole in a surface opposite to the sliding portion and a receiving hole in a surface away from the sliding portion, the rectangular hole and the receiving hole are communicated with each other, the loading member comprises a step surface formed between the rectangular hole and the receiving hole, and the rotatable member is received in the receiving hole and abuts on the step surface.

9. The lens cutting device of claim 8, wherein loading member defines a slot in a peripheral surface thereof, the slot communicates with the receiving hole, the rotatable member comprises a handle formed on a peripheral surface thereof, and the handle passes through the slot and is slidable along the slot to rotate the rotatable member.

10. The lens cutting device of claim 7, wherein the rotatable member comprises a positioning ball positioned in a surface of the rotatable member away from the sliding portion, the restricting member defines a positioning recess in a surface facing toward the rotatable member, and the positioning ball is engaged into the positioning recess to keep the rotatable member at the original position.

11. The lens cutting device of claim 7, wherein the lens cutting device comprises a driving portion connected to the cutting portion, and the driving portion is configured for driving the cutting portion to cut the lenses from the scrap.

12. The lens cutting device of claim 11, wherein the cutting portion comprises a keeping member connected to the driving portion and a cutting member connected to the keeping member, and the cutting member is configured for cutting the lenses from the scrap.

13. The lens cutting device of claim 12, wherein the keeping member comprises a fixing board fixedly connected to the driving portion and a plurality of contacting posts corresponding to the peripheral portions, the contacting posts are formed on a surface of the fixing board facing toward the separating portion, and the contacting posts contact on the lenses when the cutting member cuts the lenses from the scrap.

14. The lens cutting device of claim 13, wherein each contacting post comprises an elastic contacting head formed on a distal end of the contacting post.

15. The lens cutting device of claim 13, wherein the cutting member comprises a connecting board and a plurality of cutting tools fixed on peripheral sides of the connecting board.

16. The lens cutting device of claim 15, wherein each cutting tool comprises two blades and each blade is adjacent to a corresponding contacting post.
